(19) United States
(12) Patent Application Publication
(10) Pub. No.: US 2025/0184202 A1
(43) Pub. Date: Jun. 5, 2025

(54) DEVICE FOR SYNCHRONIZING A SYMBOL CLOCK DURING DATA TRANSMISSION AND TRANSMISSION SYSTEM

(71) Applicant: Robert Bosch GmbH, Stuttgart (DE)

(72) Inventor: Cornelius Kaiser, Rottenburg Am Neckar (DE)

(21) Appl. No.: 18/966,761

(22) Filed: Dec. 3, 2024

(30) Foreign Application Priority Data
Dec. 4, 2023 (DE) 10 2023 212 117.4

(51) Int. Cl. H04L 27/26

(52) U.S. Cl. CPC H04L 27/2662; H04L 27/2649; H04L 27/2694

(57) ABSTRACT

A device for synchronizing a symbol clock during data transmission and to a transmission system. The device has: an estimation component and a symbol synchronizer, the estimation component being configured to receive a first signal generated by the transmitter and, based on the first signal, to estimate a phase offset and/or a frequency offset between a symbol clock of the transmitter, based on which the first signal is generated, and a symbol clock of the receiver based on which the first signal is evaluated in the receiver. The device initializes the symbol synchronizer, which is a feedback symbol synchronizer, based on the estimated phase offset and/or the estimated frequency offset. The symbol synchronizer receives a second signal generated by the transmitter, and generates an output signal based on the second signal, which represents symbols synchronized with the symbol clock of the receiver that are transmitted within the second signal.

### CROSS REFERENCE

The present application claims the benefit under 35 U.S.C. § 119 of German Patent Application No. DE 10 2023 212 117.4 filed Dec. 4, 2023, which is expressly incorporated herein by reference in its entirety.

### FIELD

The present invention relates to a device for synchronizing a symbol clock during data transmission between a transmitter and a receiver, and to a transmission system having such a device.

### BACKGROUND INFORMATION

Certain transmission systems described in the related art have transmitters and receivers are not synchronized for data transmission by means of a separate clock line, so a synchronization of a symbol clock on the receiver side must be carried out in relation to a symbol clock on the transmitter side by means of data transmission signals themselves, since the particular clocks in the transmitter and receiver operate independently of one another and can therefore exhibit frequency and phase shifts relative to one another.

For this purpose, conventional feedback symbol synchronizers described in the related art can be used, which generally consist of a timing error detector, an adaptable interpolator, an interpolation controller, and a loop filter. Such feedback symbol synchronizers offer the advantage that they can be implemented with relatively little effort, i.e., they require relatively few hardware and/or software resources. On the other hand, due to the control loop, such feedback symbol synchronizers generally exhibit long settling times before achieving sufficiently accurate symbol clock synchronization. In principle, a low intrinsic noise level of the feedback symbol synchronizer is desirable. Due to the small control bandwidth required for this purpose, the settling time is disadvantageously increased. The settling time and low intrinsic noise level are in a trade-off and cannot be simultaneously improved in a straightforward manner.

In contrast to this, some conventional feedforward symbol synchronizers can achieve more rapid symbol clock synchronization due to the absence of a control loop. However, the implementation of such feedforward symbol synchronizers is generally associated with higher resource requirements in terms of hardware and/or software.

Rice, Michael. “Digital Communications: A Discrete-Time Approach,” Upper Saddle River, NJ: Prentice Hall, 2008, describes, inter alia, a feedback symbol synchronizer.

### SUMMARY

According to a first aspect of the present invention, a device for synchronizing a symbol clock during data transmission between a transmitter and a receiver is provided.

It should be noted that the present invention is specifically aimed at symbol clock synchronization between transmitters and receivers which are not synchronized through a separate clock line, but only on the basis of transmitted data signals.

According to an example embodiment of the present invention, the device has an estimation component and a symbol synchronizer, each of which can be formed from a plurality of logical and/or physical subunits. In addition, it is possible that the estimation component and/or the symbol synchronizer and/or respective subunits thereof can be designed entirely as a software implementation and/or entirely as a hardware implementation and/or as a combination of software and hardware implementations.

One particular implementation of the present invention can be realized, inter alia, on the basis of one or more computing units, which can be designed, for example, as an ASIC, FPGA, processor, digital signal processor, microcontroller or the like.

According to an example embodiment of the present invention, the estimation component is configured to receive a first signal generated by the transmitter (e.g., a predefined data preamble provided for symbol clock synchronization or a signal that differs from this) and, on the basis of the first signal, to estimate a phase offset and/or a frequency offset between a symbol clock of the transmitter, on the basis of which the first signal is generated, and a symbol clock of the receiver, on the basis of which the first signal is evaluated in the receiver.

According to an example embodiment of the present invention, the device is configured to initialize the symbol synchronizer, which is designed as a feedback symbol synchronizer, on the basis of the estimated phase offset and/or the estimated frequency offset. The symbol synchronizer is, for example, a conventional feedback symbol synchronizer from the related art, which is also configured to be initialized via suitable interfaces by means of the estimated values ascertained for the phase offset and/or the frequency offset.

Here, it is possible that the symbol synchronizer and the estimation component receive the first signal in parallel, since the symbol synchronizer is set to a defined state again by the initialization after the estimation of the frequency offset and/or the phase offset has been completed. If applicable, in this case it may be advantageous during initialization to also reset all memory and/or state variables of the symbol synchronizer to a basic initialization. Alternatively, it is also possible that the symbol synchronizer is fed with transmit signals (in particular useful signals) from the transmitter only after initialization by the estimation component has been completed. For this purpose, a corresponding logical and/or physical switch can be provided at the input of the symbol synchronizer.

It should be noted that, according to an example embodiment of the present invention, in a case in which the estimation component is designed to perform both an estimation of the phase offset and the frequency offset, a first subunit of the estimation component, which is provided for estimating the phase offset, and a second subunit of the estimation component, which is provided for estimating the frequency offset, can ascertain estimated values for the phase offset and for the frequency offset at different points in time, and that an initialization of the symbol synchronizer does not necessarily have to be carried out only if both estimated values are available. Instead, it is also possible to perform the initialization at different points in time and, for example, as soon as the particular estimated values are available.

It should further be noted that it is advantageous if processing operations within particular signal processing chains of the subunits, which are identical for both subunits, are carried out only once for both subunits by providing the respective results of the processing operations to both subunits (regardless of whether they are calculated in the first subunit, in the second subunit or in a component different therefrom), in order to save required computing and/or memory resources for the device.

Furthermore, according to an example embodiment of the present invention, it is possible that the device and in particular the estimation component has a common estimated value selector for the first subunit and the second subunit and/or separate estimated value selectors for the first subunit and the second subunit, which are configured to select a respectively suitable estimation value for the phase offset and/or the frequency offset from a plurality of generated estimation values over time, which selected values are subsequently used for the initialization of the symbol synchronizer.

The symbol synchronizer is configured to receive a second signal generated by the transmitter, in order to generate an output signal on the basis of the second signal, which output signal represents symbols synchronized with the symbol clock of the receiver that are transmitted within the second signal. In other words, the second signal is provided for actual user data transmission between the transmitter and the receiver, while the first signal is preferably provided exclusively for ascertaining the phase and/or frequency offset, i.e., for symbol clock synchronization. However, this does not explicitly rule out the possibility that the first signal can also contain useful information.

Once the symbol synchronizer has been initialized according to the present invention, it is possible to receive a plurality of further useful signals (e.g., a third signal, a fourth signal, etc.) in a manner analogous to the reception of the second signal, in order to, for example, transmit larger amounts of data from the transmitter to the receiver. In addition, it is possible to transmit a particular first signal from the transmitter to the receiver before each useful signal (which can also consist of a plurality of segmented individual signals) and/or according to predefined synchronization intervals and/or according to predefined criteria, in order to carry out a new symbol clock synchronization.

This can be advantageous, for example, if there is a longer interruption in the transmission of useful signals, which can cause the synchronization between the transmitter and the receiver to drift apart, if applicable. Even in a case in which the receiver is configured to receive useful signals from different transmitters, a new synchronization by means of an upstream transmission of the first signal by the particular transmitter can be advantageous or necessary when changing the data transmission from one transmitter to the next transmitter.

In summary, the device according to the present invention offers the particular advantage that a settling phase of the feedback symbol synchronizer can be significantly shortened by initialization by means of the estimation component for the phase offset and/or for the frequency offset compared to a conventional symbol synchronizer, as a result of which a loss-free reception of useful signals transmitted by the transmitter can take place correspondingly earlier than in the related art. As a result, response times/reaction times in a system comprising such a device can be reduced, and reliability of data transmission, etc. can be achieved.

Preferred developments of the present invention are disclosed herein.

In an advantageous example embodiment of the present invention, the estimation component is designed as a feedforward estimation component, since this makes a particularly resource-saving and/or rapid estimation of the phase offset and/or the frequency offset possible. In particular, in the case of using a feedforward estimation component, it is possible that a processing time for estimating the phase offset and/or the frequency offset is shorter than a settling time of the symbol synchronizer until a synchronized symbol clock between the transmitter and the receiver is achieved in a case in which the symbol synchronizer is not initialized by the estimation component. This does not explicitly rule out the possibility that a settling time can also be achieved on the basis of a feedback estimation component compared to a symbol synchronizer not initialized according to the present invention.

The first signal is particularly preferably a predefined synchronization signal, which can also be referred to as a preamble or training signal, for example. In this way, the first signal can be advantageously adapted to properties of a particular implementation of the estimation component with regard to a symbol sequence and/or a contained number of symbols. Since the predefined first signal of the device is known, it is also possible to implement a tailored ascertainment of the suitable selection time for the particular estimated values of a present estimated value selector, if applicable. This does not explicitly rule out the possibility that the estimation component can also achieve an advantageous estimation of the phase and/or frequency offset on the basis of a non-predefined first signal (e.g., on the basis of a random data signal and/or a useful signal). More preferably, a symbol rate of the first signal is equal to or less than a carrier frequency provided for the transmission of the first signal and the second signal.

In a further advantageous example embodiment of the present invention, the estimation component is configured to estimate the phase offset by converting sampling values representing the first signal (which are preferably generated from the first signal by an A/D converter of the device and/or the receiver) into complex sampling values by means of an IQ demodulation, preferably from the related art, the reference frequency of which corresponds to the symbol clock of the receiver and in particular to the carrier frequency described, by ascertaining a corresponding phase offset value for each of the complex sampling values and by ascertaining, from the respective phase offset values ascertained, temporal shift values, corresponding to the phase offset values, between the symbol clock of the transmitter and the symbol clock of the receiver. These temporal shift values can subsequently be used in the symbol synchronizer, in order to, for example, specify suitable new sampling times (preferably at the subsample level) for the first signal in the interpolator. It should be noted in this connection that a sampling rate of the sampling values can advantageously represent an oversampling in relation to the symbol rate, wherein the sampling rate can be further advantageously converted (in particular decimated) to a target sampling rate during or at the end of the processing chain of the estimation component and/or the symbol synchronizer. The phase offset is ascertained, for example, on the basis of an arctangent calculation that is applied to the complex sampling values. In addition, according to the particular specific implementation of the estimation of the phase offset, it is possible that further signal processing steps can be provided, in order to, for example, perform suitable scaling and/or value range shifts of results within the processing chain.

Alternatively or additionally, according to an example embodiment of the present invention, the estimation component is advantageously configured to estimate the frequency offset by converting sampling values representing the first signal into complex sampling values by means of an IQ demodulation, the reference frequency of which corresponds to the symbol clock of the receiver, by ascertaining a corresponding phase offset value for each of the complex sampling values, by avoiding overflow-induced jumps (i.e., when a predefined value range provided for the phase offset values, such as from −π to +π, is exceeded) between successive phase offset values (referred to as “unwrapping”), by converting the phase offset values into a continuously extended sequence of phase offset values, and by calculating changes between successive converted phase offset values, which changes represent a particular frequency offset. With respect to the sampling rate and oversampling that may be present, reference is made to the above description for ascertaining the phase offset, which also applies to the ascertainment of the frequency offset in this respect. Likewise, with respect to the possible calculation of the phase offset and, if applicable, additional processing steps, reference is made to the above description for ascertaining the phase offset.

In a further advantageous example embodiment of the present invention, the device is configured to ascertain, according to a reception time of the first signal and/or a duration of the first signal and/or a processing duration for the estimation of the phase offset and/or the frequency offset and/or a requirement for a minimum accuracy for the estimated phase offset and/or frequency offset, a point in time at which an estimated value for the phase offset and/or the frequency offset currently ascertained in the estimation component is selected for an initialization of the symbol synchronizer. For example, the estimated value selector described above can be used for this purpose.

Particularly preferably, according to an example embodiment of the present invention, the estimation component additionally has at least one filter, in particular a low-pass filter, which is configured to reduce noise contained in the first signal. Such a filter can be carried out, for example, after a particular IQ demodulation in the first subunit and/or in the second subunit of the estimation component and before the calculation of particular phase information from the complex sampling values. Such a filter can be designed, for example, as a moving average filter, which advantageously forms an average over a predefined number of sampling values that is equal to or less than a number of sampling values representing the entire first signal. Alternatively or additionally, it is possible to provide filtering in the processing chain for estimating the frequency offset immediately before the calculation of changes between successive converted phase offset values. Alternatively or additionally, it is also possible to provide filtering at further points within the respective processing chains for estimating the phase offset and/or the frequency offset and/or to use filtering that differs from filtering with a moving formation of an average.

According to a second aspect of the present invention, a transmission system having a transmitter and a receiver is provided, wherein the receiver comprises a device according to the first aspect of the present invention. The transmitter is configured to generate the first signal and the second signal (and preferably other signals containing useful data) on the basis of a symbol clock of the transmitter and to transmit the signals to the receiver. The receiver is configured to receive symbols representing data from the transmitter on the basis of the first signal and the second signal. The features, combinations of features and the advantages resulting therefrom correspond to those discussed in connection with the first-mentioned aspect of the present invention, such that reference is made to the above statements in order to avoid repetitions.

In an advantageous example embodiment of the transmission system according to the present invention, the transmission system has at least two transmitters, which are in each case configured to generate at least the first signal and respective second signals and to transmit these to the receiver in a non-colliding manner (e.g., by means of a time-division multiplexing method or by means of a multiplexing method differing therefrom), while the receiver is configured to receive symbols representing data from the respective transmitters on the basis of the respective first signals and second signals.

The transmission system according to the present invention is, for example, an ultrasonic system and/or a radar system, and/or a vehicle system and/or a powerline transmission system and/or a baseband transmission system and/or a transmission system differing therefrom. In the case in which the transmission system is, for example, an ultrasonic system of a vehicle, it is possible that a plurality of ultrasonic sensors arranged on the vehicle (which are arranged, e.g., in the front region and/or in the rear region of the vehicle), which function here as transmitters within the meaning of the present invention, are connected in terms of information technology via a network to a central control unit, which functions as a receiver within the meaning of the present invention. This does not rule out the possibility of bidirectional communication between the ultrasonic sensors and the central control unit. In such a case, all participants in the transmission system can advantageously have a device according to the present invention. In connection with such ultrasonic systems, it is known that the particular ultrasonic sensors transmit data to the central control unit one after the other using a time-division multiplexing method. Since the individual ultrasonic sensors generally do not have a common clock base, the device according to the present invention can be used particularly advantageously for such data communication in such an ultrasonic system, since according to the present invention a particularly rapid adaptation in the receiver to the particular symbol clock of the transmitters can be carried out, as a result of which, inter alia, short reaction times are made possible in a surrounding area detection on the basis of the ultrasonic system.

### BRIEF DESCRIPTION OF THE DRAWINGS

In the following, exemplary embodiments of the present invention are described in detail with reference to the figures.

FIG. 1 is a block diagram of an exemplary embodiment of a transmission system according to the present invention having a device according to an example embodiment of the present invention.

FIG. 2 is a block diagram of an exemplary embodiment of an estimation component according to the present invention for estimating a phase offset.

FIG. 3 is a block diagram of an exemplary embodiment of an estimation component according to the present invention for estimating a frequency offset.

FIG. 4 is a block diagram of an exemplary embodiment of a sampling value selector according to the present invention.

### DETAILED DESCRIPTION OF EXAMPLE EMBODIMENTS

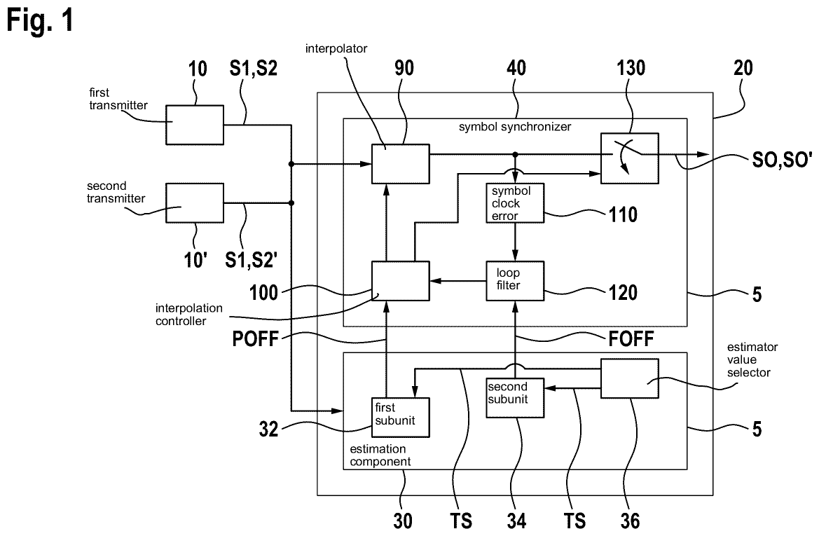

FIG. 1 is a block diagram of an exemplary embodiment of a transmission system according to the present invention having a device 5 according to the present invention, wherein the device 5 is represented by a computing unit that implements the functional blocks of the device 5 described below on the basis of a computer program that is executed by the computing unit.

The device 5 is provided for synchronizing a symbol clock during data transmission between a first transmitter 10, a second transmitter 10′ and a receiver 20, wherein the device 5 is arranged in the receiver 20. The transmitters 10, 10′, which here are in each case ultrasonic sensors of a surrounding area detection system of a vehicle, are in each case connected by wire to the receiver 20, which is a central control unit of the vehicle for receiving and evaluating surrounding area information that is detected by the ultrasonic sensors.

It should be noted that further components of the receiver 20, which are provided, for example, for pre-processing and/or further processing of received data that is transmitted by means of the data transmission between the transmitters 10, 10′ and the receiver 20, are not shown and not described here for reasons of clarity.

The device 5 has an estimation component 30 and a symbol synchronizer 40, wherein the estimation component 30 is configured to receive a first signal S1 generated by the transmitters 10, 10′ in each case in a temporally non-overlapping manner and, on the basis of the first signal S1, to estimate a phase offset POFF and a frequency offset FOFF between a particular symbol clock of the transmitters 10, 10′, on the basis of which the particular first signal S1 is generated, and a symbol clock of the receiver 20, on the basis of which the first signal S1 is evaluated in the receiver 20. The first signal S1 is formed here as a predefined preamble, the symbol rate of which is equal to or less than a carrier frequency provided for the transmission of the first signal S1.

For this purpose, the estimation component 30 has a first subunit 32, which is configured to ascertain the phase offset POFF, and a second subunit 34, which is configured to ascertain the frequency offset FOFF. In addition, the estimation component 30 has an estimated value selector 36, which is configured to ascertain a point in time TS at which a currently available estimated value for the phase offset POFF and for the frequency offset FOFF in the subunits 32, 34 is suitable for an initialization of the symbol synchronizer 40.

The device 5 is further configured to initialize the symbol synchronizer 40, which is designed here as a conventional feedback symbol synchronizer 40, on the basis of the estimated phase offset POFF and the estimated frequency offset FOFF.

The symbol synchronizer 40 is configured to receive a second signal S2 generated by the first transmitter 10 and a second signal S2′ generated by the second transmitter 10′, in order to generate respective output signals so, SO′ on the basis of the second signals S2, S2′, which output signals represent symbols synchronized with the symbol clock of the receiver 20, which are transmitted within the second signals S2, S2′.

It should be noted th′t an A/D converter (and possibly other pre-processing units) of the device 5, which converts the signals S1, S2, S2′ transmitted in analog form by the transmitters 10, 10′ into digital signals S1, S2, S2′ for further processing within the device 5, is not shown here for reasons of clarity. Preferably, such an A/D converter is connected in such a way that it provides the converted signals S1, S2, S2′ to both the symbol synchronizer 40 and the estimation component 30.

The symbol synchronizer 40 has the following components: an adaptable interpolator 90, into which the signals S1, S2, S2′ of the transmitters 10, 10′ are fed, a sampling value selector 130, by means of which the most suitable sampling value for representing a particular symbol is selected from a plurality of sampling values per transmitted symbol (i.e., there is an oversampling of the individual symbols here). The selection is preferably carried out in such a way that the sampling value per symbol is selected which has the highest signal-to-noise ratio with respect to the symbol amplitude.

The symbol synchronizer 40 further has a symbol clock error detector 110, which is configured on the basis of an algorithm from the related art to calculate a symbol clock deviation between the respective symbol clocks of the transmitters 10, 10′ and the symbol clock of the receiver 20.

The symbol synchronizer 40 also has a loop filter 120, which is implemented on the basis of a PI controller and is configured according to the present invention to be initialized by means of the frequency offset value FOFF.

Finally, the symbol synchronizer 40 has an interpolation controller 100, which is configured to be initialized according to the present invention by means of the phase offset value or by means of a temporal offset value POFF corresponding to the phase offset value and to control the interpolator 90 and the sampling value selector 130 as from the related art.

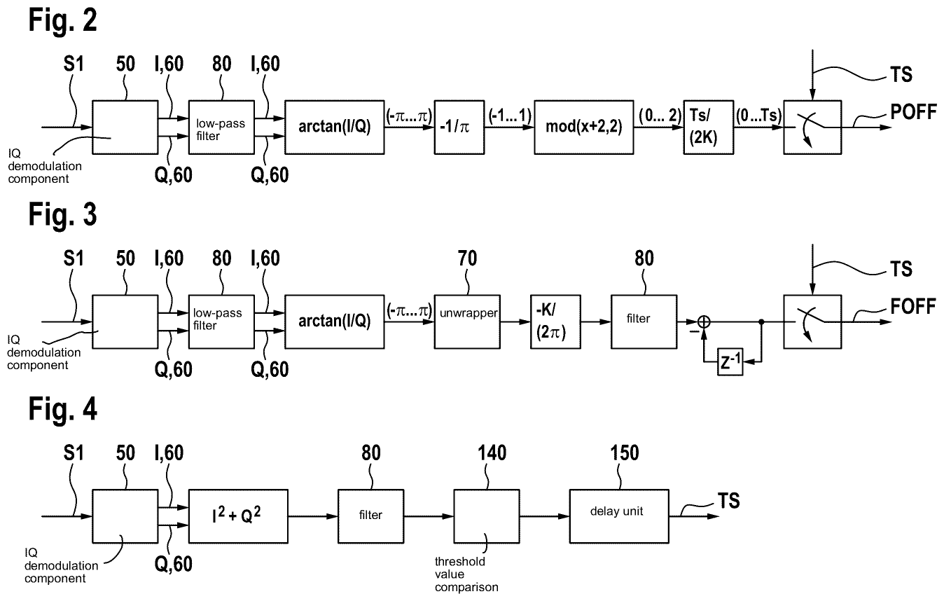

FIG. 2 is a block diagram of an exemplary embodiment of an estimation component 30 according to the present invention for estimating a phase offset POFF, wherein this part of the estimation component 30 represents the first subunit 32 of the estimation component 30 described in FIG. 1.

The first signal S1 described as in FIG. 1, which is an oversampled discrete signal, is fed into a conventional IQ demodulation component 50 from the related art, the reference frequency of which corresponds to the symbol clock of the receiver 20, in order to convert the real sampling values representing the first signal S1 into complex sampling values 60, which are represented by I-data I and Q-data Q, respectively.

The complex sampling values 60 are subsequently fed to a low-pass filter 80, which is implemented as a moving average filter, in order to reduce unwanted noise components that are contained in the complex sampling values 60.

Subsequently, on the basis of an arctangent calculation (arctan (I/Q)), respective phase offset values POFF are ascertained from the complex sampling values 60, which are initially represented by a value range from −π to +π.

The phase offset values POFF are then scaled with a factor of −1/π, in order to convert the phase offset values POFF into a value range of −1 to +1.

Due to a subsequent modulus calculation mod (x+2, 2), the particular scaled phase shift values POFF are shifted into a value range from 0 to +2, where x represents the particular scaled phase shift value POFF.

Following the modulus calculation, the phase offset values POFF are scaled to a value range between 0 and Ts by means of a factor Ts/(2K), where K corresponds to the number of sampling values per symbol and Ts corresponds to the symbol time interval.

Finally, a phase offset value POFF suitable for the initialization of the symbol synchronizer 40 is selected from a plurality of temporally successively ascertained phase offset values POFF. This selection is carried out on the basis of the point in time TS described in FIG. 1, which is ascertained by the estimated value selector 36 also described in FIG. 1 and subsequently in FIG. 4.

FIG. 3 is a block diagram of an exemplary embodiment of an estimation component 30 according to the present invention for estimating a frequency offset FOFF, wherein this part of the estimation component 30 represents the second subunit 34 of the estimation component 30 described in FIG. 1.

The first signal S1 described as in FIG. 1, which is an oversampled discrete signal, is fed into a conventional IQ demodulation component 50 from the related art, the reference frequency of which corresponds to the symbol clock of the receiver 20, in order to convert the real sampling values representing the first signal S1 into complex sampling values 60, which are represented by I-data I and Q-data Q, respectively.

The complex sampling values 60 are subsequently fed to a low-pass filter 80, which is implemented as a moving average filter, in order to reduce unwanted noise components that are contained in the complex sampling values 60.

Subsequently, on the basis of an arctangent calculation (arctan (I/Q)), respective phase offset values POFF are ascertained from the complex sampling values 60, which are represented by a value range from −π to +π.

In the subsequent unwrapper 70, overflow-induced jumps between successive phase offset values POFF at the value range limits are avoided by converting the phase offset values POFF into a continuously extended sequence of phase offset values POFF within a correspondingly enlarged value range.

A scaling of the converted phase offset values POFF is then carried out by means of a factor −K/2π, where K corresponds to the number of sampling values per symbol.

For further noise reduction, further filtering 80 is subsequently provided in the processing chain of FIG. 3, which filtering can, for example, be identical to the filtering in the preceding filter 80 of the block diagram or implemented differently.

In the subsequent processing step in the processing chain, a differentiation of the sampling values processed as above is carried out by subtracting successive sampling values from one another. For this purpose, the delay element z−1 with negative feedback is provided, through which, in each case, a previous sampling value is subtracted from the currently processed sampling value. The changes ascertained in this way between successive converted phase offset values POFF represent a particular frequency offset FOFF.

Finally, a frequency offset value FOFF suitable for the initialization of the symbol synchronizer is selected from a plurality of temporally successively ascertained frequency offset values FOFF. This selection is carried out on the basis of the point in time TS described in FIG. 1, which is ascertained by the estimated value selector 36 also described in FIG. 1 and subsequently in FIG. 4.

FIG. 4 is a block diagram of an exemplary embodiment of a sampling value selector 130 according to the present invention, which here is a sampling value selector 130 according to FIG. 1 to 3 described above.

The first signal S1 described as in FIG. 1, which is an oversampled discrete signal, is fed into a conventional IQ demodulation component from the related art, the reference frequency of which corresponds to the symbol clock of the receiver 20, in order to convert the real sampling values representing the first signal S1 into complex sampling values 60, which are represented by I-data I and Q-data Q, respectively.

In the following block of the block diagram in FIG. 4, the magnitude squared of the particular complex sampling values 60 is ascertained.

The magnitude squared values are subsequently fed to a low-pass filter 80, which is implemented as a moving average filter in order to reduce unwanted noise components contained in the magnitude squared values.

Particular output values from the low-pass filter 80 are compared with a predefined threshold value in a block for a threshold value comparison 140, wherein the threshold value is specified in such a way that exceeding the threshold value indicates a particular start of the first signal S1.

By means of a subsequently arranged delay unit 150, the point in time TS described in the above figures is ascertained starting from the point in time of the beginning of the first signal S1, by adding a delay time to the point in time of the beginning of the first signal S1, which delay time is specified according to a processing duration of the estimation component 30 (see FIGS. 1, 2, and 3) and according to a duration of the first signal S1.

What is claimed is:

1. A device for synchronizing a symbol clock during data transmission between a transmitter and a receiver, the device comprising:
an estimation component; and
a symbol synchronizer;
wherein:
the estimation component is configured to:
receive a first signal generated by the transmitter, and
estimate, based on the first signal, a phase offset and/or a frequency offset, between a symbol clock of the transmitter, based on which the first signal is generated, and a symbol clock of the receiver, based on which the first signal is evaluated in the receiver;
the device is configured to initialize the symbol synchronizer, which is a feedback symbol synchronizer, based on the estimated phase offset and/or the estimated frequency offset; and
the symbol synchronizer is configured to receive a second signal generated by the transmitter, and generate an output signal based on the second signal, the output signal representing symbols synchronized with the symbol clock of the receiver that are transmitted within the second signal.

2. The device according to claim 1, wherein:
the estimation component is a feedforward estimation component, and/or
a processing time for estimating the phase offset and/or the frequency offset is shorter than a settling time of the symbol synchronizer until a synchronized symbol clock between the transmitter and the receiver is reached in a case in which the symbol synchronizer is not initialized using the estimation component.

3. The device according to claim 1, wherein:
the first signal is a predefined synchronization signal, and/or
a symbol rate of the first signal is equal to or less than a carrier frequency provided for transmission of the first signal and the second signal.

4. The device according to claim 1, wherein the estimation component is configured to estimate the phase offset by:
converting sampling values representing the first signal into complex sampling values using an IQ demodulation, a reference frequency of which corresponds to the symbol clock of the receiver,
ascertaining a corresponding respective phase offset value for each of the complex sampling values, and
ascertaining, from the respective phase offset values ascertained, temporal shift values, corresponding to the phase offset values, between the symbol clock of the transmitter and the symbol clock of the receiver.

5. The device according to claim 1, wherein the estimation component is configured to estimate the frequency offset by:
converting sampling values representing the first signal into complex sampling values using an IQ demodulation, a reference frequency of which corresponds to the symbol clock of the receiver,
ascertaining a corresponding phase offset value for each of the complex sampling values,
avoiding overflow-induced jumps between successive phase offset values, by converting the phase offset values into a continuously extended sequence of phase offset values, and
calculating changes between successive converted phase offset values, which changes represent a particular frequency offset.

6. The device according to claim 1, wherein the device is configured to ascertain, according to:
a reception time of the first signal, and/or
a duration of the first signal, and/or
a processing time for the estimation of the phase offset and/or the frequency offset, and/or
a requirement for a minimum accuracy for the estimated phase offset and/or frequency offset,
wherein a point in time at which an estimated value for the phase offset (and/or the frequency offset currently ascertained in the estimation component s selected for an initialization of the symbol synchronizer.

7. The device according to claim 1, wherein the estimation component includes has at least one filter, which is configured to reduce noise contained in the first signal.

8. A transmission system, comprising:
a transmitter; and
a receiver including a device for synchronizing a symbol clock during data transmission between a transmitter and a receiver, the device including:
an estimation component, and
a symbol synchronizer,
wherein:
the estimation component is configured to:
receive a first signal generated by the transmitter, and
estimate, based on the first signal, a phase offset and/or a frequency offset, between a symbol clock of the transmitter, based on which the first signal is generated, and a symbol clock of the receiver, based on which the first signal is evaluated in the receiver,
the device is configured to initialize the symbol synchronizer, which is a feedback symbol synchronizer, based on the estimated phase offset and/or the estimated frequency offset, and
the symbol synchronizer is configured to receive a second signal generated by the transmitter, and generate an output signal based on the second signal, the output signal representing symbols synchronized with the symbol clock of the receiver that are transmitted within the second signal,
wherein:
the transmitter is configured to generate the first signal and the second signal based on on the symbol clock of the transmitter and to transmit the first and second signals to the receiver, and
the receiver is configured to receive symbols representing data from the transmitter based on the first signal and the second signal.

9. The transmission system according to claim 8, wherein:
the transmission system has at least two transmitters, which are in each case configured to generate at least a respective first signal and respective second signals and to transmit the respective first signal and the respective second signals to the receiver in a non-colliding manner, and
the receiver is configured to receive symbols representing data from each of the transmitters based on the respective first signals and second signals.

10. The transmission system according to claim 8, wherein the transmission system is
an ultrasonic system, and/or
a radar system, and/or
a vehicle system, and/or
a powerline transmission system, and/or
a baseband transmission system.
